(19) United States
(12) Patent Application Publication
(10) Pub. No.: US 2023/0311713 A1
(43) Pub. Date: Oct. 5, 2023

(54) COOLING SYSTEM

(71) Applicant: MAHLE International GmbH, Stuttgart (DE)

(72) Inventors: Richard Bruemmer, Stuttgart (DE); Christian Buerck, Boeblingen (DE); Achim Koppehel, Kornwestheim (DE); Rainer Lutz, Steinheim (DE); Jan Schultes, Stuttgart (DE); Thomas Strauss, Notzingen (DE)

(21) Appl. No.: 18/015,958

(22) PCT Filed: Jun. 18, 2021
(86) PCT No.: PCT/EP2021/066623

§ 371 Date: Jan. 12, 2023

(30) Foreign Application Priority Data
Jul. 13, 2020 (DE) 10 2020 208 712.1

(51) Int. Cl. B60L 58/33; F28D 3/02; F28D 1/053

(52) U.S. Cl. CPC B60L 58/33; F28D 3/02; F28D 1/05366; F28D 2021/0043

(57) ABSTRACT

A cooling system for a fuel cell of a motor vehicle may include a closed coolant circuit through which a coolant is circulatable, a heat exchanger fluidically incorporated in the coolant circuit for cooling the coolant, an open sprinkler circuit through which a sprinkler fluid is flowable for cooling the heat exchanger, and a channel structure fluidically incorporated in the sprinkler circuit. The heat exchanger may include an air inlet surface, an air outlet surface, and a plurality of cooling tubes. The coolant may be flowable through the heat exchanger via the plurality of cooling tubes. Air may be flowable through the heat exchanger from the air inlet surface to the air outlet surface. The channel structure may include a plurality of channels, which may each include a plurality of outlet nozzles via which the sprinkler fluid is appliable to the plurality of cooling tubes.

### CROSS-REFERENCE TO RELATED APPLICATIONS

This application claims priority to International Patent Application No. PCT/EP2021/069439 filed Jul. 13, 2021, which also claims priority to German Patent Application DE 10 2020 208 710.5 filed Jul. 13, 2020, each of which is hereby incorporated by reference in its entirety.

### TECHNICAL FIELD

The invention relates to a heat exchanger as well as a fuel cell assembly comprising such a heat exchanger. The invention additionally relates to a method for producing such a heat exchanger.

### BACKGROUND

In the case of conventional fuel cells, which is understood hereinafter to be a hydrogen-oxygen fuel cell, hydrogen is oxidized by means of oxygen as oxidizing agent, and a majority of the energy released thereby is tapped in electrical form. Compared to a combustion of the hydrogen by means of oxygen, a comparatively small portion of the energy released during the oxidation is thereby generated as heat. In technical jargon, the oxidation process, which takes place in the fuel cell, is thus often also referred to as “cold combustion”. Such fuel cells have been used for some time in motor vehicles in order to supply electrical energy or power, respectively, to an electrical drive train of such a motor vehicle.

During the cold combustion, the hydrogen is oxidized by means of the oxygen into water, which is released by the fuel cell as (by—)product of the cold combustion. This water can be reused for various purposes, thus for controlling the temperature of a heat exchanger or of a temperature control fluid, respectively, which flows through this heat exchanger.

However, it often turns out to be technically problematic thereby to realize a guidance of the water in or on the heat exchanger, respectively.

With that in mind, it is an object of the present invention—in particular in order to take into account the above challenge—to show new ways for heat exchangers as well as for fuel cell assemblies comprising such a heat exchanger, and for methods for producing a heat exchanger.

This object is solved by means of the heat exchanger, of the fuel cell assembly, and of the method disclosed herein.

### SUMMARY

It is thus the basic idea of the invention to form at least one tube body, through which air can flow, of a heat exchanger comprising a fluid channel, through which a fluid can flow, and comprising a water channel, which is fluidically separated from the fluid channel and through which water can flow. The water channel is thereby formed to be fluidically open to the outside in such a way that at least one of the tube bodies can be wetted externally with water, which is guided through the water channel. The water channel guiding the water can thus advantageously be integrated into the tube body, which makes separate water pipes obsolete. This is reflected in a particularly low mounting effort and, associated therewith, in cost advantages in the production.

A heat exchanger according to the invention, which is advantageously suitable for a use in a fuel cell assembly, has several tube bodies, which are in each case arranged at a distance from one another and which are in each case formed so that a fluid, in particular a liquid or a gas, can flow through internally, and so that air can flow around externally. A water channel, through which water can flow—fluidically separated from the fluid—is thereby arranged in or on at least one tube body. At least one opening, via which the water channel communicates fluidically with the external environment of this tube body, is formed in this at least one tube body. The at least one opening is arranged in the tube body so that at least one of the tube bodies can be wetted with water, which is guided through the water channel and which escapes from the water channel through the opening. At least one of the tube bodies can preferably be sprinkled with water, which is guided through the water channel and which escapes from the water channel through the opening. As already suggested above, the water channel guiding the water can thus advantageously be integrated into at least one of the tube bodies, so that additional water pipes can be saved, which has a positive impact on the mounting effort and the production costs of the heat exchanger. The heat exchanger according to the invention is furthermore of particularly compact construction, which is advantageous in particular in the motor vehicle industry due to the installation space conditions, which are typically extremely tight there.

According to a preferred further development of the heat exchanger, the at least one tube body comprising the water channel comprises a circumferential wall, by means of which a fluid channel, through which the fluid can flow, is fluidically separated from the external environment of the tube body. To form the water channel, this at least one tube body additionally has a separating wall, which fluidically separates the water channel from the fluid channel. The circumferential wall and the separating wall are thereby preferably molded integrally on one another, i.e. formed in one piece and of the same material. This allows for a realization of the at least one tube body in the water channel, which is of particularly compact construction.

In the case of a further advantageous further development of the heat exchanger, it is provided that the tube bodies extend along a direction of extension and are arranged at a distance from one another along a transverse direction running transversely to the direction of extension. The transverse direction preferably corresponds essentially to a direction of gravity in an operating position of the heat exchanger. As a result, an exterior of a tube body, which is adjacent to the tube body comprising the water channel in the transverse direction, in particular arranged below the tube body comprising the water channel in the direction of gravity, can be wetted, in particular sprinkled, with water from the water channel via the opening as a result of the effect of gravity. A particularly efficient heat transfer between the water and the heat exchanger or the fluid, which flows through the heat exchanger, respectively, is advantageously attained therewith.

In the case of a further preferred further development of the heat exchanger, a water channel comprising a corresponding opening of the respective tube body is in each case formed in several, preferably in all, of the tube bodies of the heat exchanger. The at least one opening is thereby preferably formed in the circumferential wall of the respective tube bodies. The wetting or sprinkling, respectively, with the water can thus advantageously take place over a particularly large surface, which increases the efficiency of the heat exchanger between heat exchanger or the fluid and the water flowing through said heat exchanger, respectively.

A further advantageous further development of the heat exchanger provides that the water channel is fluidically open transversely to the direction of extension and along the transverse direction via the opening of the tube body having the water channel. This turns out to be particularly advantageous under fluidic aspects.

In the case of another advantageous further development of the heat exchanger, the at least one opening is formed so as to extend in an interruption-free manner over the entire length of the respective tube body along the direction of extension of the respective tube body. The water channel is thus formed in the manner of an open trough of the respective tube body. Such a water channel impresses due to a good accessibility for maintenance or cleaning purposes, respectively.

According to a further preferred further development of the heat exchanger, the tube body comprising the water channel has several openings, which are open transversely to the direction of extension. These several openings of the respective tube body are arranged at a distance from one another, preferably with respect to the direction of extension and/or the transverse direction, particularly preferably so as to be distributed regularly or irregularly. This allows for a particularly even discharge of the water, which flows through the water channel, via the openings.

A further advantageous further development of the heat exchanger provides that at least one of the tube bodies comprises at least one fluid channel separating wall, which runs internally along the direction of extension and which divides the fluid channel into partial fluid channels, which are fluidically separated from one another and which are preferably connected fluidically in parallel in the heat exchanger. Such a fluid channel separating wall has an advantageous mechanically stiffening effect on the respective tube body and thus also on the entire heat exchanger.

In the case of another preferred further development of the heat exchanger, the heat exchanger comprises a case, which is preferably formed in a housing-like manner and which internally limits a fluid chamber and a water chamber, which are fluidically separated from one another in a case interior of the case by means of a case separating wall as part of the case. The water chamber and the fluid chamber are thereby covered by means of a tube bottom, which has apertures for receiving a respective tube body. The tube bodies are in each case received in one of the apertures of the tube bottom provided for this purpose along the direction of extension at one end in such a way that the water channel is connected to the water chamber, and the fluid channel is connected to the fluid chamber so as to fluidically communicate therewith. The fluid chamber can act as fluid collector for collecting the fluid after flowing through the tube bodies, or as fluid distributor for distributing the fluid to the tube bodies. The water chamber can act as water collector for collecting the water after flowing through the at least one water channel, or as water distributor for distributing the water to the at least one water channel. Individual supply or discharge pipes, which are fluidically connected to the tube bodies or the at least one water channel, respectively, can thus be saved in an advantageous manner.

According to a further advantageous further development of the heat exchanger, the tube body having the water channel has a recess, which is recessed along the direction of extension, on a front side of the tube body, which runs transversely to the direction of extension thereof, between the water channel and the fluid channel. This recess is arranged between two appendages, which are in each case molded on the front side of the tube body in a region of the water channel and in a region of the fluid channel. The tube bottom thereby has a first aperture, via which the water chamber is fluidically open to the outside. The tube bottom further has a second aperture, via which the fluid chamber is fluidically open to the outside. The appendage molded on the front side of the tube body in the region of the water channel is received in the first aperture of the tube bottom, and the appendage molded on the front side of the tube body in the region of the fluid channel is received in the second aperture. The appendages are received in the first or second aperture of the tube bottom, respectively, in such a way that the water channel is connected to the water chamber, and the fluid channel is connected to the fluid chamber fluidically communicating therewith. This allows for a particularly reliable fastening of the tube bodies on the tube bottom.

According to another advantageous further development of the heat exchanger, at least one, preferably each of the apertures of the tube bottom is encased by a passage collar, which is molded integrally on the tube bottom. This passage collar preferably protrudes from the tube bottom, facing the case interior. In the alternative, the passage collar can protrude from the tube bottom, facing away from the case interior. A joining surface between tube bottom and the tube body, which is received in the aperture comprising the passage collar, is advantageously enlarged by means of such a passage collar.

According to an advantageous further development, the heat exchanger has a protective grid comprising bars for protecting the tube body or the tube bodies, respectively, against falling rocks.

The water channel is advantageously arranged between the at least one tube body and the protective grid. This alternative has a particularly compact construction.

The protective grid, in particular at least one bar of the protective grid, partially limits the water channel, preferably together with the tube body. The water channel, which is partially limited by the protective grid, is particularly preferably formed to be open.

According to a further preferred embodiment, the at least one tube body comprising the water channel is connected by means of a substance-to-substance bond to the at least one other tube body, which is formed so that the fluid can flow through. This makes it possible to separately produce the tube body or the water channel, respectively, and to fasten it to the tube body, which forms or limits the fluid channel, respectively, only after the production.

The at least one tube body comprising the water channel can particularly preferably consist of the water channel. In other words, the tube body comprising the water channel serves the purpose of only limiting this water channel, and does not limit a fluid channel, through which the fluid can flow.

The at least one tube body comprising the water channel is advantageously connected to a water collector, which is formed separately from a fluid collector, which is connected to the at least one tube body, through which the fluid can flow. Different embodiments can thus be selected for fluid collector and water collector. A protective grid can in particular be provided on the water collector.

The invention additionally relates to a fuel cell assembly, which is preferably configured for a use in a motor vehicle. The fuel cell assembly comprises a fuel cell, which releases waste water during the operation as a product of cold combustion. The fuel cell assembly additionally comprises a heat exchanger according to the invention according to the above description, the water channel of which can be supplied or is supplied with the waste water released by the fuel cell. The above-described advantages of the heat exchanger according to the invention also transfer to the fuel cell assembly according to the invention comprising such a heat exchanger.

The invention further relates to a method for producing a heat exchanger according to the invention as described above. The method comprises four measures a), b), c), and d). According to measure a), provision of tube bodies takes place, which are formed so that a fluid can flow through internally and so that air can flow around externally. In or on at least one of the tube bodies, a water channel is additionally formed, through which water, in particular waste water of a fuel cell, can flow—fluidically separated from the fluid. Measure b) of the method provides for an arrangement of the tube bodies on a tube bottom, so that the tube bodies are received in apertures, of the tube bottom, which are provided for this purpose. According to measure c), a substance-to-substance joining, in particular soldering or adhesion, of the tube bodies with the tube bottom takes please, so that a fluid-tight joint is created between the tube bodies and an aperture of the tube bottom, which receives the respective tube body. According to measure d), at least one opening of the at least one tube body having the water channel is created. The above-described advantages of the heat exchanger according to the invention transfer analogously also to the method according to the invention for producing such a heat exchanger.

In the case of an advantageous further development of the method, measure d) is performed chronologically prior to measures b) and c). This has the advantage of a simplified creation of the at least one opening because the tube bodies, which are not yet installed, can be handled more easily. In the alternative, measure d) is performed chronologically between measure b) and measure c). This allows for a particularly precise alignment of the at least one opening to a target position of the at least one opening in the completed heat exchanger. In the alternative, measure d) is performed chronologically after measures b) and c). This allows for a particularly secure clamping or fixing, respectively, of the heat exchanger when creating the at least one opening.

In measure d), the at least one opening is advantageously created mechanically, in particular by means of machining and/or punching and/or crimping. A heat input into the material of the tube body is thus kept advantageously low. In the alternative or in addition, the at least one opening is created thermally, in particular by means of a laser in measure d). Such a thermal creation of the at least one opening requires a particularly low manufacturing time.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations, or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically

FIG. 1 shows an example of a heat exchanger according to the invention in a section along a direction of extension of tube bodies of the heat exchanger,

FIG. 2 shows a further example of the heat exchanger according to the invention in a section along the direction of extension of the tube bodies of the heat exchanger,

FIG. 3 shows, in an exemplary manner, a flow chart of a method according to the invention for producing a heat exchanger,

FIGS. 4a to 4c show examples of tube bodies for the heat exchanger according to the invention, in each case in a section transversely to the direction of extension,

FIGS. 5a to 5c show further examples of tube bodies for the heat exchanger according to the invention, in each case in a section transversely to the direction of extension,

FIGS. 6a to 6c show further examples of tube bodies for the heat exchanger according to the invention, in each case in a section transversely to the direction of extension,

FIGS. 7 to 10 show further examples of heat exchangers according to the invention, in each case in a section transversely to the direction of extension,

FIGS. 11a, 11b show an alternative of the example of FIG. 1, in which the tube body limiting the water channel is connected by means of a substance-to-substance bond to the tube body limiting two fluid channels as part of the production of the heat exchanger.

### DETAILED DESCRIPTION

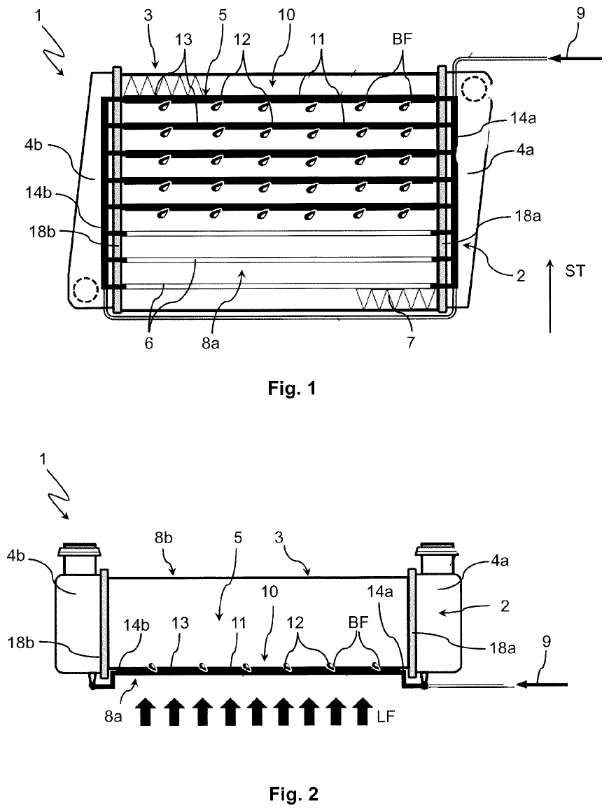

In FIGS. 1 and 2, an example of a heat exchanger 1 according to the invention is in each case shown in a roughly schematic manner in a section along a direction of extension E, along which tube bodies 2 of the heat exchanger 1 extend. The heat exchanger 1 is configured for a use in a fuel cell assembly according to the invention. The heat exchanger 1 comprises several tube bodies 2, which are in each case arranged at a distance from one another. The tube bodies 2 are in each case formed so that a fluid F can flow through internally, and so that air L can flow around externally. A water channel 5, through which water W can flow—fluidically separated from the fluid F—is arranged in or on at least one of the tube bodies 2. An opening 6 is formed in this at least one tube body 2 comprising the water channel 5. The water channel 5 communicates fluidically with the external environment of the respective tube body 2 via the opening 6. The opening 6 is thereby arranged in the tube body 2 so that at least one of the tube bodies 2 of the heat exchanger 1 can be wetted with the water W, which is guided through the water channel 5 and which escapes through the opening 6. For example, at least one of the tube bodies 2 can be sprinkled with this water W, which escapes from the water channel 5 through the opening 6.

In FIGS. 4a, 4b, and 4c, examples are in each case illustrated in a cut manner on tube bodies 2 for the heat exchanger 1 according to the invention transversely to their direction of extension E. The tube bodies 2 according to these examples are thereby in each case formed as folding tube.

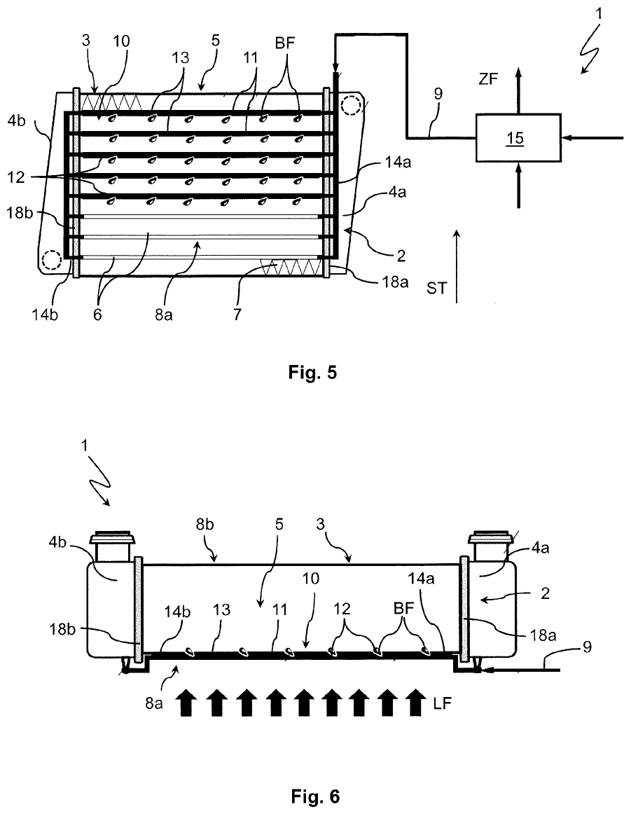

FIGS. 5a, 5b, 5c, as well as 6a and 6b in each case show examples on tube bodies 2 for the heat exchanger 1 according to the invention, cut transversely to their direction of extension E. The tube bodies 2 according to these examples are thereby in each case formed as extrusion tube or welding tube.

It can be gathered from FIGS. 1, 2, 4a, 4b, 4c, 5a, 5b, 5c, as well as 6a and 6b that the tube body 2 comprises a circumferential wall 21, by means of which a fluid channel 4 of the tube body 2, through which the fluid F can flow, is fluidically separated from the external environment of the tube body 2. To form the water channel 5, the at least one tube body 2 comprising the water channel 5 has a separating wall 22. The separating wall 22 fluidically separates the water channel 5 from the fluid channel 4. According to the shown examples, circumferential wall 21 and the separating wall 22 are thereby molded integrally on one another.

In the examples of the heat exchanger 1 of FIGS. 1 and 2, the tube bodies 2 are arranged at a distance from one another along a transverse direction Q, which runs transversely to the direction of extension E. The transverse direction Q corresponds essentially to a direction of gravity G, for example in an operating position of the heat exchanger 1, so that an exterior 3 of a tube body 2, which is adjacent to the tube body 2 comprising the water channel 5 in the transverse direction Q, can be wetted or sprinkled, respectively, with water W from the water channel 5 via the opening 6 as a result of the effect of gravity on the water W.

In the examples of FIGS. 1 and 2, a water channel 5 comprising a corresponding opening 6 of the respective tube body 2 is in each case formed in several tube bodies 2. A water channel 5 comprising a corresponding opening 6 of the respective tube body 2 can be formed in each tube body 2 of the heat exchanger 1. According to the shown examples, the at least one opening 6 is thereby formed in the circumferential wall 21 of the tube body 2 having the water channel 5.

According to the examples of FIGS. 5b and 5c, the water channel 5 is fluidically open transversely to the direction of extension E and along the transverse direction Q via the opening 6 of the tube body 2 having the water channel 5.

FIGS. 6a and 6b illustrate that in these examples of the tube body 2 for the heat exchanger 1, the opening 6 is formed to extend in an interruption-free manner along the direction of extension E of the tube body 2 having the water channel 5 over the entire length of said tube body. According to these examples, the water channel 5 is thus formed in the manner of an open trough 7 of the respective tube body 2.

FIG. 2 shows that the tube body of the heat exchanger 1 having the water channel 5 has, for example, several openings 6, which are open transversely to the direction of extension E. The several openings 6 of this tube body are thereby arranged at a distance from one another. With respect to the direction of extension E, and, in the alternative or in addition, with respect to the transverse direction Q, the several openings 6 of the tube body 2 can be arranged at a distance from one another. The several openings 6 can thereby be arranged so as to be distributed regularly or irregularly.

FIGS. 4c, 5c, as well as 6a and 6b in each case show that at least one of the tube bodies 2 comprises, for example, a fluid channel separating wall 8, which runs internally along the direction of extension E. The fluid channel separating wall 8 thereby divides the fluid channel 4 into partial fluid channels 9, which are fluidically separated from one another. The partial fluid channels 9 can be connected fluidically in parallel in the heat exchanger 1.

FIGS. 1 and 2 further illustrate that the heat exchanger 1 comprises a case 10, which is formed in a housing-like manner. Internally, the case 10 limits a fluid chamber 11 and a water chamber 12. The fluid chamber 11 and the water chamber 12 are fluidically separated from one another in a case interior 10 of the case 11 by means of a case separating wall 14 of the case 11. The water chamber 12 and the fluid chamber 11 are thereby covered by means of a tube bottom 15 of the heat exchanger 1. The tube bottom 15 has apertures 16 for receiving a respective tube body 2. The apertures 16 can be formed, for example, as passages. The tube bodies 2 are in each case received in one of the apertures 16 of the tube bottom 15 provided for this purpose along the direction of extension E at one end. The tube bodies 2 are thereby received in the apertures 16 in such a way that the water channel 5 of the at least one tube body 2 having the water channel 5 is connected to the water chamber 12, and the fluid channel 4 of the tube bodies 2 is connected to the fluid chamber so as to fluidically communicate therewith.

According to the example of FIG. 2, the tube body 2 comprising the water channel 5 has a recess 18, which is recessed along the direction of extension E, on a front side 17 of the tube body 2, which runs transversely to the direction of extension E thereof. This recess 18 is arranged on the front side 17 of the tube body 2 between the water channel 5 and the fluid channel 4. The recess 18 is arranged between two appendages 19, which are in each case molded on the front side 17 of the tube body 2 in a region of the water channel 5 and in a region of the fluid channel 4. According to the shown example, the tube bottom 15 thereby has a first aperture 16, 16a, via which the water chamber 12 is fluidically open to the outside. The tube bottom additionally has a second aperture 16, 16b, via which the fluid chamber 15 is fluidically open to the outside. In the shown example, the first and the second aperture 16, 16a, 16b are arranged at a distance from one another transversely to the direction of extension E and transversely to the transverse direction Q. It can further be seen that the appendage 19 molded on the front side 17 of the tube body 2 in the region of the water channel 5 is received in the first aperture 16, 16a of the tube bottom 15. The appendage 19 molded on the front side 17 of the tube body 2 in the region of the fluid channel 4 is received in the second aperture 16, 16b of the tube bottom 15. The appendages 19 are thereby received in the first or the second aperture 16, 16a, 16b, respectively, in such a way that the water channel 5 is connected to the water chamber 12, and the fluid channel 4 is connected to the fluid chamber 11 fluidically communicating therewith.

At least one of the apertures 16, 16a, 16b of the tube bottom 15, for example each of these apertures 16, 16a, 16b, is encased by a passage collar, which is molded integrally on the tube bottom 15, but which is not shown in the figures for reasons of clarity. The passage collar can protrude, for example, from the tube bottom 15, facing the case interior 13.

The heat exchanger 1 of FIGS. 1 and 2 can be encased by a fuel cell assembly according to the invention. This fuel cell assembly has a fuel cell, which releases waste water WA during the operation as a product of cold combustion. The water channel 5 of the heat exchanger 1 can or is thereby supplied, respectively, with the waste water WA, which is released by the fuel cell.

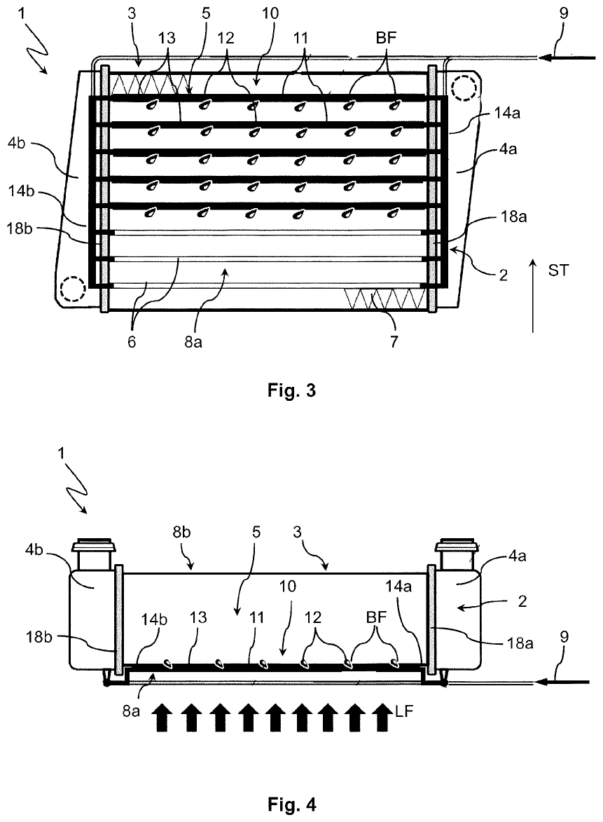

In FIG. 3, a method 20 according to the invention for producing a heat exchanger 1 according to the invention, for example the heat exchanger 1 of FIG. 1 or 2, is illustrated by means of a flow chart. It can be seen that the method 20 comprises four measures a), b), c), and d). According to measure a), tube bodies 2 are thereby provided, which are formed so that a fluid F can flow through internally and so that air L can flow around externally. In at least one of these tube bodies 2, a water channel 4 is additionally formed, through which water W, for example waste water WA of a fuel cell, can flow—fluidically separated from the fluid F. Measure b) provides that the tube bodies 2 are arranged on a tube bottom 15 of the heat exchanger 1 to be produced, so that the tube bodies 2 are received in apertures, of the tube bottom 15, which are provided for this purpose. According to measure c), a substance-to-substance joining, for example soldering or adhesion, of the tube bodies 2 with the tube bottom 15 takes please, so that a fluid-tight joint is created between the tube bodies 2 and an aperture 16 of the tube bottom 15, which receives the respective tube body 2. A creation of at least one opening of the at least one tube body 2 having the water channel 5 additionally takes place according to measure d).

According to the example of FIG. 3, measures a) to d) of the method 20 are performed chronologically in the order a)-b)-c)-d). Measure d) is thus performed, for example, chronologically after measures b) and c). In the alternative, measure d) of the method 20 can be performed chronologically prior to measures b) and c) or chronologically between measures b) and c). In measure d), the at least one opening 6 is created mechanically. Such a mechanical creation of the opening 6 can take place by means of machining, punching, or crimping—or a combination thereof. In the alternative or in addition, the creation of the at least one opening 6 according to measure d) can take place thermally, for example by means of a laser.

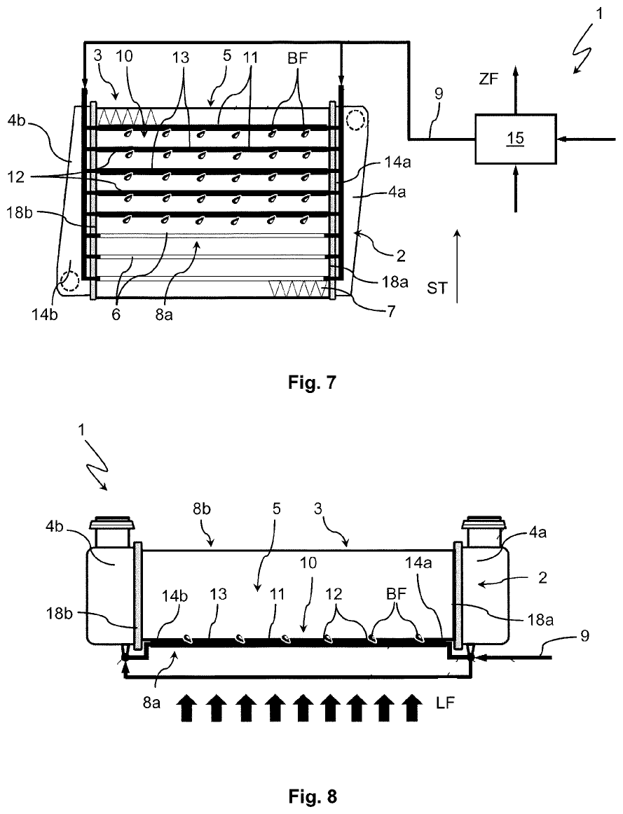

Various further examples of the heat exchanger 1 according to the invention are shown in FIGS. 7 to 10, in each case cut transversely to the direction of extension E. According to this, the heat exchanger 1 can have a protective grid 24, which has bars 24a. This protective grid 24 can serve to protect the tube body or the tube bodies 2, respectively, against falling rocks. Together with one of the tube bodies 2, one of the bars 24a can in each case limit the water channel 5. The water channel 5 can thus be arranged between the respective tube body 2 and the respective bar 24a, viewed transversely to the direction of extension E and to the transverse direction Q.

According to FIGS. 7 to 10, the respective bar 24a can extend along the direction of extension E. Facing the tube body 2, a bar depression 25 extending along the direction of extension E can thereby be present on the respective bar 24a. It can further be seen that a web 23, which can act as flow guide element, can be present on both sides of the tube body 2 with respect to the transverse direction Q. Several such webs 23 can thereby be arranged at a distance from one another along the direction of extension E on both sides of the tube body 2.

FIG. 7 shows that the tube bodies 2 and the webs 23 can be flush with one another transversely to the transverse direction Q and transversely to the direction of extension E. The respective bar 24a of the protective grid 24 can thereby be arranged at a distance from the respective tube body 2 and the webs 23 transversely to the direction of extension E and transversely to the transverse direction Q.

In contrast, it can be gathered from FIG. 8 that the separating wall 22 of the tube body 2 cannot be flush with the webs 23, viewed transversely to the transverse direction Q and transversely to the direction of extension E. On the contrary, the separating wall 22 can be recessed transversely to the transverse direction Q and transversely to the direction of extension E. The respective bar 24a of the protective grid 24 can thereby rest against the webs 23 transversely to the transverse direction Q and transversely to the direction of extension E.

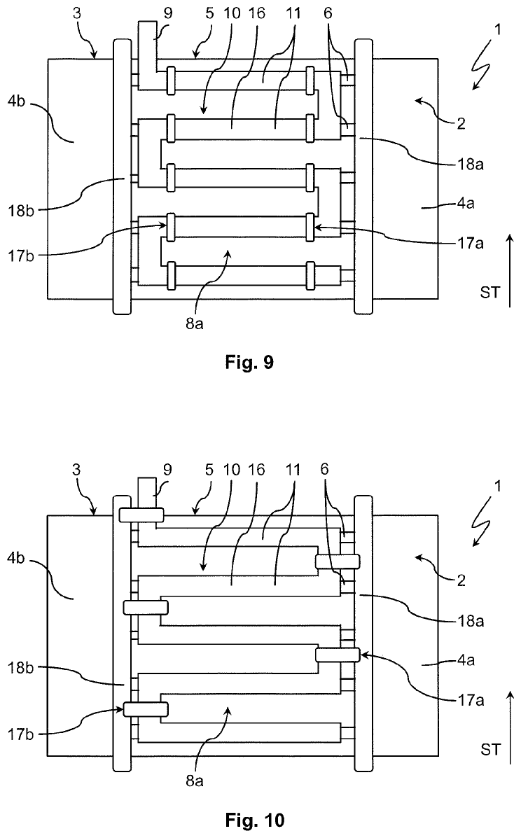

According to the example of FIG. 9 and as also in the example of FIG. 8, the separating wall 22 of the tube body 2 can be recessed inwards, transversely to the transverse direction Q and transversely to the direction of extension E. According to FIG. 9, the respective bar 24a of the protective grid 24 can thereby be arranged between the webs 23, viewed along the transverse direction Q.

It can additionally be gathered from the example of FIG. 10 that the respective bar 24a of the protective grid 24 can rest against the webs 23 on the outside, transversely to the transverse direction Q and transversely to the direction of extension E.

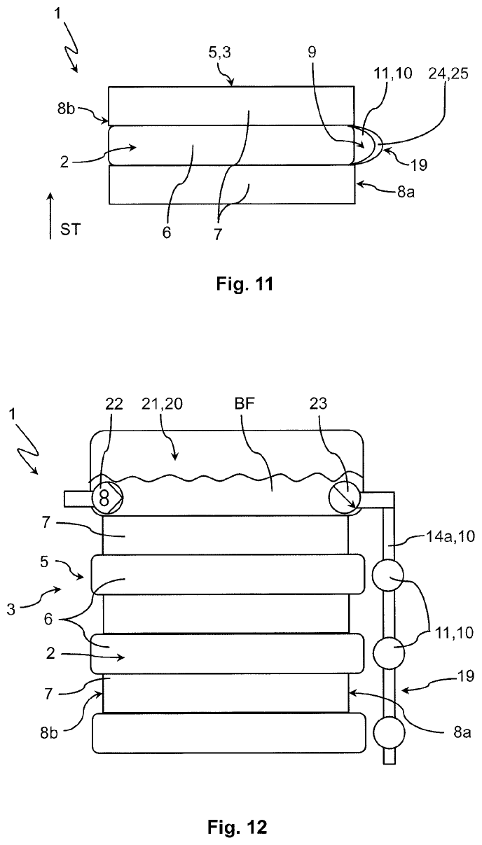

In a sectional illustration, FIG. 11a shows a further alternative, in particular of the example of FIG. 1, in which the tube body 2 comprising the water channel 5 for water W to flow through—this tube body 2 is additionally identified with reference numeral 27 in FIG. 11—is connected by means of a substance-to-substance bond 26—for example by means of an adhesive connection or solder connection or weld connection—to the tube body 2, which limits two fluid channels 4 for the fluid F to flow through in the example scenario. This makes it possible to separately produce the tube body 27 or the water channel 5, respectively, and to fasten it to the tube body 2 or to the fluid channels 4, respectively, only after the production.

FIG. 11b is a top view onto the alternative of FIG. 11a. It can be seen that in the case of the alternative of FIGS. 11a, 11b, two separate cases 10, which are in each case formed in a housing-like manner, are provided for the two fluid channels 4 as well as for the water channel 5—in contrast to the example of FIG. 1. One of the two cases 10, which acts as fluid collector 29 for the fluid F, which flows through the two fluid channels 4, limits the fluid chamber 11 internally. The other one of the two cases 10 limits the water chamber 12 as water collector 28. Individual technical embodiments can thus be used for both cases 10, in particular for the case 10 acting as fluid collector 29. A protective grid 24 can be provided on the water collector 28.

1. A cooling system for a fuel cell of a motor vehicle, comprising:
a closed coolant circuit through which a coolant is circulatable;
at least one heat exchanger fluidically incorporated in the coolant circuit for cooling the coolant, the at least one heat exchanger including an air inlet surface, an air outlet surface, and a plurality of cooling tubes, the coolant flowable through the at least one heat exchanger via the plurality of cooling tubes, air flowable through the at least one heat exchanger from the air inlet surface to the air outlet surface;
an open sprinkler circuit through which a sprinkler fluid is flowable for cooling the at least one heat exchanger;
a channel structure fluidically incorporated in the sprinkler circuit, the channel structure including a plurality of channels, the channel structure arranged in parallel with and directly adjacent to the air inlet surface; and
wherein the plurality of channels each include a plurality of outlet nozzles via which the sprinkler fluid is appliable to the plurality of cooling tubes.

2. The cooling system according to claim 1, further comprising a flexible hose, wherein:
the channel structure further includes two retaining units;
the two retaining units are (i) disposed spaced apart from one another and in parallel with one another, (ii) at least one of integrally moulded on and attached to the at least one heat exchanger, and (iii) arranged on both sides of the air inlet surface:
the plurality of channels are formed by the flexible hose; and
the flexible hose extends meander-like between the two retaining units under tension and is attached to the at least one heat exchanger.

3. The cooling system according to claim 1, further comprising a plurality of stiff tubes and at least one distribution line, wherein:
the plurality of channels are formed by the plurality of stiff tubes and the at least one distribution line
the at least one distribution line fluidically connects the plurality of stiff tubes with one another on one side; and
the plurality of stiff tubes are at least partially embedded in the at least one heat exchanger and at least one distribution line is completely embedded in the at least one heat exchanger.

4. The cooling system according to claim 1, further comprising a plurality of stiff tubes and at least one distribution line, wherein:
the plurality of channels are formed by the plurality of stiff tubes and the at least one distribution line;
the at least one distribution line fluidically connects the plurality of stiff tubes with one another on one side;
the plurality of stiff tubes and the at least one distribution line are connected to the channel structure in an integrally bonded manner; and
the channel structure is attached to the at least one heat exchanger in at least one of a force-fitted manner, an integrally bonded manner, and a form-fitted manner.

5. The cooling system according to claim 1, further comprising a separate channel wall plate, wherein:
the channel wall plate includes a plurality of elongated wall elements arranged directly in front of the plurality of cooling tubes, the plurality of wall elements connected to the plurality of cooling tubes in a fluid-tight manner; and
the plurality of channels are formed between and delimited towards an outside by the plurality of wall elements and the plurality of cooling tubes.

6. The cooling system according to claim 1, wherein the plurality of channels are finned towards an outside, at least in regions, to increase an area of an outer surface of the plurality of channels.

7. The cooling system according to claim 1, wherein a flow cross-section of the plurality of channels decreases in a flow direction of the sprinkler fluid such that a pressure of the sprinkler fluid in the channel structure is uniform.

8. The cooling system according to claim 1, wherein:
plurality of channels are formed by a porous material; and
the plurality of outlet nozzles are defined by a plurality of pores of the porous material.

9. The cooling system according to claim 1, wherein:
the plurality of channels are oriented in parallel with one another and are each arranged directly in front of the plurality of cooling tubes; and
the channel structure completely covers the air inlet surface such that the channel structure forms a stone guard for the at least one heat exchanger.

10. The cooling system according to claim 1, further comprising a radiator for temperature controlling the sprinkler fluid, wherein:
the radiator is fluidically incorporated in the sprinkler circuit; and
the sprinkler fluid and a second coolant of a second coolant circuit are flowable through the radiator.

11. The cooling system according to claim 1, wherein the sprinkler fluid in the sprinkler circuit is temperature controlled.

12. The cooling system according to claim 1, further comprising a collecting tank for collecting the sprinkler fluid, wherein:
the collecting tank is fluidically incorporated in the sprinkler circuit upstream of the channel structure;
the collecting tank, during operation of the cooling system is arranged above the channel structure; and
the collecting tank is at least one of (i) formed in the at least one heat exchanger and (ii) attached to the at least one heat exchanger.

13. The cooling system according to claim 1, wherein:
the plurality of channels are formed by a fluid-tight material; and
the plurality of outlet nozzles are defined by a plurality of openings that are disposed in the fluid-tight material and that open towards the air inlet surface.

14. The cooling system according to claim 1, further comprising a flexible hose and a plurality of retaining units, wherein:
the flexible hose defines the plurality of channels; and
the plurality of retaining units are configured as a plurality of clips, are clipped to the plurality of cooling tubes, and connect the flexible hose to the plurality of cooling tubes.

15. The cooling system according to claim 1, further comprising a flexible hose including:
a plurality first sections that define the plurality of channels of the channel structure, the plurality of first sections each extending along and adjacent to an associated cooling tube of the plurality of cooling tubes; and
a plurality of second sections that extend transversely to the plurality of first sections, each of the plurality of second sections extending between and connecting an associated pair of adjacent first sections of the plurality of first sections.

16. The cooling system according to claim 15, further comprising a plurality of retaining units connecting the plurality of first sections of the flexible hose to the plurality of cooling tubes.

17. The cooling system according to claim 15, further comprising a plurality of retaining units, wherein:
the at least one heat exchanger includes two fluid tanks between which the plurality of cooling tubes extend; and
the plurality of retaining units connect the plurality of second sections of the flexible hose to the two fluid tanks.

18. A cooling system for a fuel cell of a motor vehicle, comprising:
a closed coolant circuit through which a coolant is circulatable;
a heat exchanger fluidically incorporated in the coolant circuit for cooling the coolant;
the heat exchanger including a plurality of cooling tubes via which the coolant is flowable through the heat exchanger;
the heat exchanger having an air inlet surface and an air outlet surface via which air is flowable through the heat exchanger in an air flow direction;
an open sprinkler circuit through which a sprinkler fluid is flowable for cooling the heat exchanger;
a stone guard arranged directly in front of the plurality of cooling tubes relative to the air flow direction; and
a channel structure fluidically incorporated in the sprinkler circuit, the channel structure including a plurality of channels defined by and between the stone guard and the plurality of cooling tubes such that the sprinkler fluid flowing therethrough directly contacts the plurality of cooling tubes.

19. A cooling system for a fuel cell of a motor vehicle, comprising:
a closed coolant circuit through which a coolant is circulatable;
a heat exchanger fluidically incorporated in the coolant circuit for cooling the coolant;
the heat exchanger including a plurality of cooling tubes via which the coolant is flowable through the heat exchanger;
the heat exchanger having an air inlet surface and an air outlet surface via which air is flowable through the heat exchanger in an air flow direction;
an open sprinkler circuit through which a sprinkler fluid is flowable for cooling the heat exchanger;
a stone guard arranged directly in front of the plurality of cooling tubes relative to the air flow direction;
the stone guard including a channel structure fluidically incorporated in the sprinkler circuit;
wherein the channel structure includes a plurality of channels that each include a plurality of outlet nozzles via which the sprinkler fluid is appliable directly to the plurality of cooling tubes.

20. The cooling system according to claim 19, further comprising a collecting tank for collecting the sprinkler fluid, wherein:
the collecting tank is fluidically incorporated in the sprinkler circuit upstream of the channel structure; and
the collecting tank is arranged above the channel structure such that sprinkler fluid within the collecting tank is flowable into the channel structure via gravity.
